(19) United States
(12) Patent Application Publication
(10) Pub. No.: US 2017/0243225 A1
(43) Pub. Date: Aug. 24, 2017

(54) SYSTEMS AND METHODS FOR USING MULTI-PARTY COMPUTATION FOR BIOMETRIC AUTHENTICATION

(71) Applicant: MasterCard International Incorporated, Purchase, NY (US)

(72) Inventor: Manoneet Kohli, O'Fallon, MO (US)

(21) Appl. No.: 15/051,929

(22) Filed: Feb. 24, 2016

(51) Int. Cl. G06Q 20/40; H04L 29/06

(52) U.S. Cl. CPC G06Q 20/40145; H04L 63/0861

(57) ABSTRACT

Multi-party computation systems and methods for user biometric authentication. In some embodiments, a biometric authentication service computer receives a user authentication request from an entity, determines user enrollment in the biometric authentication service, transmits a prompt message to a user device for at least one type of user biometric feature data, receives the biometric feature data, determines at least two biometric authentication system computers, separates the user biometric feature data into at least two user biometric data portions, transmits each of those portions to a separate biometric authentication system computer. An authentication message is then received from each of the biometric authentication computer systems, and a positive user authentication response is transmitted to the entity computer when the authentication message from each of the biometric authentication computer systems indicates a positive user authentication.

### FIELD OF THE INVENTION

Embodiments generally relate to systems and methods for using multi-party computation for biometric authentication. More particularly, embodiments relate to authenticating a user based on biometric data captured during a transaction.

### BACKGROUND OF THE INVENTION

Many modern day transactions involve a user operating a mobile device, such as a consumer operating a cellphone or smartphone, to purchase merchandise or service(s). In other scenarios, a person may utilize his or her mobile device to gain access or entry to, for example, an office building or mass transportation station. When the transaction at hand is financial in nature, and/or includes security concerns, the consumer or user is typically required to participate in a user authentication process and/or transaction authorization process. Some authentication systems in use today will thus typically require the user to provide a personal identification number (“PIN”) and/or a password and/or the like, which was preset by the user during a registration process, in order to conduct the transaction. It is also becoming increasingly common to utilize biometric technology to provide improved security and/or improved user authentication.

Payment card issuers and other financial institutions now offer or use standardized Internet purchase transaction protocols to improve online transaction performance and to encourage and/or accelerate the growth of electronic commerce. Under some standardized protocols, payment card issuers and/or issuing financial institutions, such as banks, may authenticate purchase transactions thereby reducing the likelihood of fraud and associated chargebacks attributed to payment card account (cardholder) not-authorized transactions. One example of a standardized protocol is the 3-D Secure Protocol, which leverages existing Secure Sockets Layer (SSL) encryption functionality and provides enhanced security through issuer authentication of the cardholder during an online (i.e., over the Internet) shopping session. The 3-D Secure protocol is consistent with and underlies the authentication programs offered by many payment card issuers (for example, Verified by Visa™ and/or MasterCard® SecureCode™) to authenticate customers for merchants during remote transactions such as those associated with the Internet.

Many payment card issuers and/or issuing banks are now also considering and/or implementing biometric technology to increase security for both online transactions (card not present (CNP) transactions) and card present or face-to-face transactions occurring, for example, in a merchant's retail store. However, consumers and/or cardholders are sometimes hesitant or decline to enroll or register for biometric authentication services because they are concerned about the security of their biometric data. In particular, if inadequately protected, a consumer's biometric data may be stolen by vandals and then misappropriated throughout the consumer's lifetime to conduct fraudulent transactions. For example, if a biometric database containing, for example, fingerprint data of a plurality of consumers is hacked, then the hackers (thieves or vandals) have obtained access to that personal identification biometric data (the fingerprint data) which is unique to those consumers (because biometric data is not alterable or changeable). The stolen biometric data can then be utilized for nefarious purposes by the hackers during the lifetime of those consumers because it is not possible for the consumers to reset or otherwise change their biometric data. In contrast, if a consumer authentication database containing personal identification numbers (PINs) and/or passwords is hacked, then consumers need only change or replace their PINs and/or passwords upon being notified of the security breach to thwart the hackers.

It would therefore be desirable to provide systems and/or methods which provide improved security for user biometric data so as to encourage and/or promote the adoption of biometric authentication services by users (such as consumers and/or businesses).

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1 is a block diagram of an example of a user biometric authentication and transaction system operable for authenticating a user based on biometric data obtained during a transaction in accordance with an embodiment of the disclosure;

FIG. 2 is a block diagram of an embodiment of a user mobile device illustrating some biometric hardware aspects in accordance with some embodiments of the disclosure;

FIG. 3 is a flowchart illustrates a user enrollment process in accordance with some embodiments of the disclosure;

FIG. 4 is a flowchart illustrating an entity enrollment process according to some embodiments of the disclosure; and

FIG. 5 is a flowchart illustrating a method for utilizing biometric feature data to authenticate a user in accordance with some embodiments of the disclosure.

### DETAILED DESCRIPTION

In general, and for the purpose of introducing concepts of novel embodiments described herein, provided are systems and methods for authenticating users that involve obtaining user biometric data of a particular type during an enrollment process, separating the biometric feature data into two or more user biometric feature data portions, and then distributing the biometric feature data portions among two or more separate biometric authentication system computers. The separate biometric authentication system computers each store their respective different user biometric feature data portion for future use to conduct user authentication processing. Thus, when the user then engages in a transaction, in some implementations a biometric authentication service system computer receives a request for user authentication and then prompts the user to provide the biometric feature data. Once received, that biometric feature data is separated into the two or more biometric feature data portions and then the biometric authentication service system computer transmits each biometric feature data portion to each of two or more authentication systems for user authentication processing. In particular, each of the two or more authentication system computers operates separately and/or independently of, and without any awareness of, the other authentication system computer(s) to both store and then later validate a user biometric feature data portion captured during a transaction by comparing it to a stored biometric feature data portion. Thus, in some embodiments, the biometric authentication service system computer functions as a processing interface to first obtain one or more particular types of biometric feature data from a registered user during a transaction, then to second separate the received user biometric feature data into two or more user biometric data portions, then to third transmit each of the user biometric feature data portions to an appropriate biometric authentication system computer for user authentication processing. For example, the biometric authentication service system computer may obtain fingerprint data from a registered user, then separate that data into a first portion associated with the right side of the fingerprint and a second portion associated with the left side of the fingerprint, and then transmit the first portion to a first biometric authentication system computer and transmit the second portion to a second biometric authentication system computer for authentication. If the biometric authentication service system computer then receives a positive user authentication message from each one of the biometric authentication system computers (which means that each of the user biometric feature data portions has been separately validated), then the biometric authentication service system computer transmits a user authentication message to the entity (such as a merchant or issuer) involved in the transaction. However, if any one of the biometric authentication system computers transmits a mismatch message (which means that the user biometric feature portion does not match stored data), then the biometric authentication service system computer transmits a negative authentication message to the entity involved in the transaction.

In some embodiments, a biometric authentication service system computer receives a user authentication request from an entity computer, wherein the user authentication request includes transaction data, user identification data and entity identification data. The biometric authentication service system computer then determines, based on the user identification data, that the user is enrolled in a biometric authentication service and transmits prompt messages to a user device of the user requesting certain biometric feature information from the user. The biometric authentication service system computer receives the requested biometric feature data, separates that data into user biometric feature portion data and then determines which two or more biometric authentication computer systems should receive the biometric feature portion data. The biometric authentication service computer next transmits the biometric feature data portions to the appropriate biometric authentication system computer, and then receives from each of the biometric authentication system computers, an authentication message. When each of the authentication messages from the biometric authentication computer systems indicates a positive authentication of the user, then the biometric authentication service system computer transmits a positive user authentication response to the entity computer. However, if any one of the authentication messages from the biometric authentication computer systems indicates a mismatch of biometric data, then the biometric authentication service system computer transmits a negative user authentication message to the entity computer.

For ease of understanding, embodiments are described herein with regard to payment transactions and/or purchase transactions and/or other financial transactions. However, those skilled in the art, upon reading this disclosure, will appreciate that the disclosed biometric user authentication systems and processes may be used with desirable results to conduct other types of transactions that require biometric authentication, such as a user or employee obtaining entry to a secure building or a consumer and/or cardholder obtaining entry to a transportation hub such as a train station or bus station. In some embodiments, the user of the disclosed biometric user authentication system may be an authority or government agency, such as homeland security, having reasons for checking the biometrics of one or more persons (e.g. at a border control crossing or, for example, when police arrest a person on suspicion of criminal activity). A number of terms will be used herein. The use of such terms are not intended to be limiting, but rather are used for convenience and ease of exposition. For example, as used herein, the term “user” may be used interchangeably with the term “consumer” and/or the with the term “cardholder” and these terms are used herein to refer to a person, individual, consumer, business or other entity or organization that owns (or is authorized to use) a financial account such as a payment card account (such as a credit card account or debit card account) or some other type of account (such as a loyalty card account or mass transit access account). In addition, the term “payment card account” may include a credit card account, a debit card account, a loyalty card account and/or a deposit account or other type of financial account that an account holder or cardholder may access. The term “payment card account number” includes a number that identifies a payment card system account or a number carried by a payment card, and/or a number that is used to route a transaction in a payment system that handles debit card and/or credit card transactions and the like. Moreover, as used herein the terms “payment card system” and/or “payment network” refer to a system and/or network for processing and/or handling purchase transactions and/or related transactions, which may be operated by a payment card system operator such as MasterCard International Incorporated, or a similar system. In some embodiments, the term “payment card system” may be limited to systems in which member financial institutions (such as banks) issue payment card accounts to individuals, businesses and/or other entities or organizations (and thus are known as issuer financial institutions or issuer banks). In addition, the terms “payment system transaction data” and/or “payment network transaction data” or “payment card transaction data” or “payment card network transaction data” refer to transaction data associated with payment or purchase transactions that have been or are being processed over and/or by a payment network or payment system. For example, payment system transaction data may include a number of data records associated with individual payment transactions (or purchase transactions) of cardholders that have been processed over a payment card system or payment card network. In some embodiments, payment system transaction data may include information such as data that identifies a cardholder, data that identifies a cardholder's payment device and/or payment card account, transaction date and time data, transaction amount data, and an indication of the merchandise and/or services that have been purchased, and information identifying a merchant and/or a merchant category. Additional transaction details and/or transaction data may also be available and/or utilized for various purposes in some embodiments.

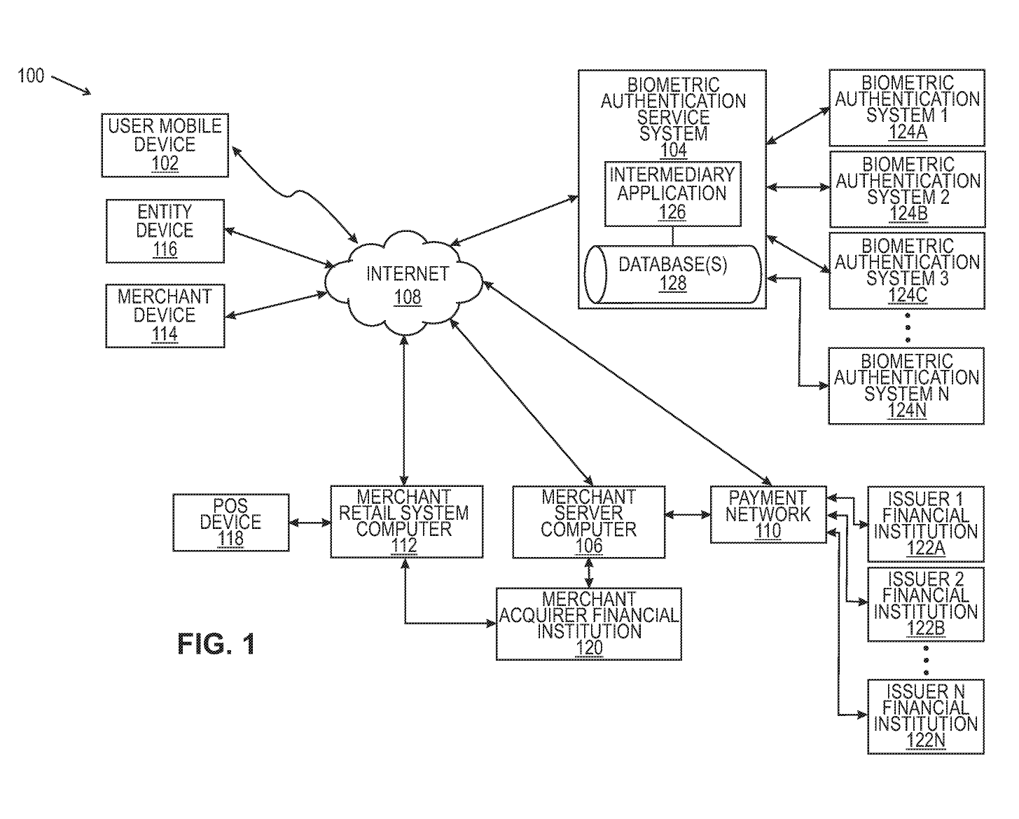

Features of some embodiments will now be described by reference to FIG. 1, which is a block diagram illustrating the components of a user biometric authentication and transaction system 100 operable for authenticating a user based on biometric data obtained during a transaction pursuant to some embodiments. As shown, a transaction system pursuant to some embodiments involves a number of devices and/or entities interacting to conduct a transaction. For example, users may operate wireless mobile devices 102 to interact with a biometric authentication service system computer 104 and/or a merchant server computer 106 via the Internet 108 in accordance with the novel aspects described herein. In addition, in some implementations the biometric authentication service system computer 104 is configured to communicate with a payment network 110 and/or the merchant server computer 106 and/or the merchant retail system computer 112 and/or a merchant device 114 and/or an entity device 116 via the Internet 108 in accordance with aspects described herein. In addition, in some implementations the user's mobile device 102 may be configured for wirelessly communicating with a merchant's point-of-sale (POS) device 118 to conduct a purchase transaction, and/or for communicating with the entity device 116. As depicted in FIG. 1, the POS device 118 is connected to the merchant retail system computer 112, which is operably connected to a merchant acquirer financial institution (FI) computer 120, and the merchant acquirer FI computer 120 may also be operably connected to the payment network 110. The payment network 110 is operably connected to a plurality of issuer FI computers 122, which hold customer financial accounts (such as consumer payment card accounts), including Issuer1 FI computer 122A, Issuer2 FI computer 122B to IssuerN FI computer 122N. In addition, the biometric authentication service system computer 104 is shown operably connected to a plurality of biometric authentication system computers 124, including biometric authentication system1 computer 124A, biometric authentication system2 computer 124B, biometric authentication system3 computer 124C, and biometric authentication systemN computers 124N. The biometric authentication service system computer 104 also may include an intermediary application 126 stored in a system memory or storage device (not shown), and one or more database(s) 128. The intermediary application 126 includes instructions configured to cause the biometric authentication service system computer 104 to function in accordance with the processes and/or methods disclosed herein. It should be understood that, while only a single user mobile device 102, a single merchant server computer 106, a single payment network 110, a single merchant retail system computer 112, a single merchant device 114, a single entity device 116, a single POS device 118, and a single authentication service system computer 104 are shown in FIG. 1, in practice a large number of such devices and/or components and/or elements may be involved in a user biometric authentication and transaction system in accordance with the novel aspects disclosed herein. Thus, the various blocks or components of the system shown in FIG. 1 may include or be comprised of one or more computers, computer networks, and/or computer systems. Furthermore, although the various components of the transaction system 100 are shown connected via the Internet 108 for communications purposes, the components of a suitable biometric authentication and transaction system may instead be configured for communication with each other via other types of networks and/or network connections, including proprietary and/or secure network connections.

Referring again to FIG. 1, the user mobile device 102 may be a smart phone, tablet computer, digital music player, laptop computer, smart watch, personal digital assistant (PDA), digital wearable device or the like, which includes hardware and/or software components that can be configured to provide functionality and/or operations in accordance with the characteristics (hardware and/or software) of that particular type of mobile device in order to obtain and/or transmit biometric data and to conduct transactions with entities, such as merchants (either in a retail location or online or over another type of network connection) and/or transportation providers (for example, via communications with an electronic turnstile to gain access to a mass transit station or vehicle). For example, if the user mobile device is a tablet computer, then it may include hardware and software components such as a touch screen display, a microphone, a speaker, a digital camera, controller circuitry, one or more sensor components, an antenna, a memory or storage device, and software stored in a storage device and configured to provide tablet computer functionality. It also should be understood that storage devices utilized in the electronic devices and/or system components described herein may be composed of, or be any type of, non-transitory storage device capable of storing instructions and/or software code for causing one or more processors of such electronic user devices to function in accordance with the novel aspects disclosed herein.

The mobile device 102 of FIG. 1 may also include a number of logical and/or functional components (in addition to the normal components found in a mobile device), such as one or more biometric data acquisition applications (or other software and/or middleware components to provide the functionality) and one or more biometric authenticators (i.e., biometric sensors) for obtaining user biometric data. Embodiments may also utilize secure push authentication technology and/or other techniques or technology compatible with the user mobile device to deliver an optimal user experience. Examples of biometric authenticators resident in the user mobile device 102 include, but are not limited to, a fingerprint reader, a microphone or voice reader (including appropriate audio software), and/or a digital camera. The digital camera may be utilized, for example, in some circumstances to capture a photograph of one or more portions of the user's face during a transaction, and the facial feature data transmitted by the user mobile device 102 to the biometric authentication service system computer 104 for biometric authentication system processing via a facial recognition process in accordance with the methods disclosed herein. It should be understood that some user mobile devices 102 may include two or more authenticators (or components which may be used as authenticators) in different combinations (for example, a smartphone may include a microphone and a camera, but may lack a dedicated fingerprint reader and/or an iris scanner, while other types of user mobile devices may include all of these authenticators). Moreover, some types of user mobile devices may only include one type of authenticator, for example a microphone which can be configured to obtain user voice print data.

A user and/or consumer and/or cardholder may utilize the mobile device 102 to communicate with the biometric authentication service system computer 104 in order to enroll or register in a biometric authentication service to perform a user authentication process pursuant to the novel aspects described herein. Thus, in some implementations, the biometric authentication service system computer 104 includes one or more components (such as storage device(s) configured as database(s)) for storing information associated with users, user devices and/or other system participants (such as, for example, information associated with entities such as merchants and/or transportation providers that wish to utilize the features of the novel systems and/or processes disclosed herein). In particular, the biometric authentication service system computer 104 may include components including an interface (not shown) that can be implemented as a Web service (which is a method of communicating between two electronic devices over a network) using, for example, a Simple Object Access Protocol (SOAP) and/or Representational State Transfer (REST) or other techniques. Thus, the interface may be a SOAP/REST interface which allows communication between user mobile devices 102 and other entities and/or their devices.

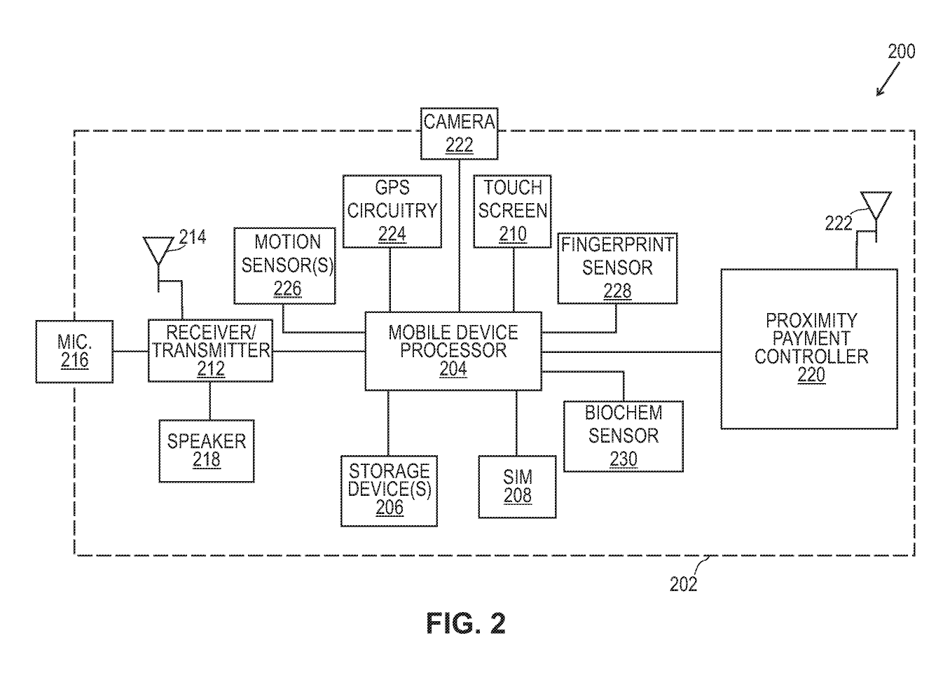

FIG. 2 is a block diagram of an embodiment of a user mobile device 200 illustrating hardware aspects that may be utilized to capture user biometric data, for example, during an enrollment or registration process and/or during a transaction, and to transmit the user biometric data to a biometric authentication service system computer, for example, for use in authenticating the user in accordance with embodiments described herein. In this example, the user mobile device 200 is a mobile telephone or smartphone that is capable of conducting wireless transactions, and that may (but need not) have capabilities for functioning as a contactless payment device. In particular, the mobile device 200 may be a payment-enabled mobile telephone capable of conducting purchase transactions at merchant retail locations, and also capable of being utilized for online purchase transactions. For example, the user mobile device 200 includes a proximity payment controller 220 and associated antenna that can communicate with a merchant's reader device. Thus, the user mobile device 200 may include hardware that is configured to provide novel functionality as described herein. In some other embodiments, however, novel functionality as described herein may result at least partially from novel software and/or middleware and/or firmware components that program or instruct one or more mobile device processors of the mobile device 200.

The mobile telephone 200 may include a conventional housing (indicated by dashed line 202) that contains and/or supports the other components of the mobile telephone. The mobile telephone 200 includes a mobile device processor 204 for controlling over-all operation. The mobile device processor 204 may be, for example, suitably programmed to allow the mobile telephone to engage in data communications and/or text messaging with other wireless devices and/or electronic devices (such as proximity reader devices), and to allow for interaction with web pages accessed via browser software over the Internet, as described herein. Other components of the mobile telephone 200, which are in communication with and/or are controlled by the mobile device processor 204 include one or more storage devices 206 (for example, program memory devices and/or working memory and/or secure storage devices, and the like), a subscriber identification module (SIM) card 208, and a touch screen display 210 configured to display information and/or to receive user input.

The mobile telephone 200 also includes receive/transmit circuitry 212 that is also in communication with and/or controlled by the mobile device processor 204. The receive/transmit circuitry 212 is operably coupled to an antenna 214 and provides the communication channel(s) by which the mobile telephone 200 communicates via a mobile network (not shown). The mobile telephone 200 further includes a microphone 216 operably coupled to the receive/transmit circuitry 212, which the microphone 216 is operable to receive voice input from the user. In addition, a loudspeaker 218 is also operably coupled to the receive/transmit circuitry 212 and provides sound output to the user.

As mentioned earlier, the mobile telephone 200 may also include a proximity payment controller 220 which may be a specially designed integrated circuit (IC) or chipset. The proximity payment controller 220 may be a specially designed microprocessor that is operably connected to an antenna 222 and may function to interact with a Radio Frequency Identification (RFID) and/or Near Field Communication (NFC) proximity reader (not shown), which may be associated, for example, with a Point-of-Sale (POS) terminal of a merchant. For example, the proximity payment controller 220 may provide information and/or data, such as a user's payment card account number, when the user is using the mobile device 200 to conduct a purchase transaction to pay for merchandise, for example, by communicating with a reader associated with a POS terminal of a merchant in a retail store location.

The user's mobile device 200 may include one or more sensors and/or circuitry that function to provide and/or obtain user identification data and/or user biometric data from the user. For example, the user mobile device may be a Smartphone including one or more components and/or authenticators such as an integrated camera 222, a microphone 216, global positioning sensor (GPS) circuitry 224, one or more motion sensors 226, a fingerprint sensor 228 and/or a biochemical sensor 230 which are operably connected to the mobile device processor 204. Some of the authenticators may be configured to obtain biometric data from the user of the smartphone, such as the camera 222 (facial recognition data), the motion sensor 226 (gesture data and/or walking gait data), the fingerprint sensor 228 (fingerprint data), the biochemical sensor 239 (breath data). One or more additional types of biometric authenticators or components (not shown), such as heart rate sensors and/or heart rate monitors, blood pressure sensors, iris and/or retina detectors or sensors, oxygen sensors, glucose and/or blood sugar sensors, pedometers and/or speed sensors, body temperature sensors, and the like, could also be utilized to obtain biometric data from the user for authentication processing in accordance with the processes described herein. It should also be understood that one or more of the biometric sensors might not be included within the housing 202 of the mobile device 200, but may instead take the form of a peripheral component that is operably connected (for example, via a USB cable, or wirelessly using the BlueTooth protocol) to the mobile telephone. Examples of such peripheral components include, but are not limited to, plug-in or otherwise operably connectable digital cameras, heart-rate sensors resident within smart watches configured for communications with mobile telephones, and/or one or more forms of biometric sensor(s) located in apparel such as smart bands (which can be worn by a consumer, for example, as an armband, an ankle band, or a wristband).

In some embodiments, the authenticators can be used to perform multiple tasks. For example, the integrated camera 222 functions normally to take digital pictures, and may also be utilized to obtain facial data of the user, and may be operable to read two-dimensional (2D) and/or three-dimensional (3D) barcodes to obtain information. Moreover, the camera may be configured as a thermal imaging device and/or a digital camera and/or a webcam to capture video images. Thus, the camera may be used to take a picture or video footage of the user's face (and/or of other relevant portions of the user) in accordance with processes described herein. In addition, the microphone 216 may be utilized by a user, for example, during a telephone call and additionally during a user biometric authentication service enrollment process (discussed in more detail below), wherein user voice print data is obtained from the user and then stored according to the processes described herein.

Referring again to FIG. 2, the GPS circuitry 224 may be operable to generate information concerning the location of the user and/or user mobile telephone 200. In addition, the motion sensor(s) 226 may be operable to generate motion data, for example, that may be transmitted to the biometric authentication service system computer 104 for processing during a transaction and used to authenticate a user. For example, data may be generated that can be used to identify the user's walking style or gait. In another example, the motion sensor(s) 226 may operate to generate force data associated with, for example, the force generated by the user's finger when he or she touches the touch screen 210.

Referring again to FIG. 2, the fingerprint sensor 228 may include a touch pad or other component (not shown) for use by the user to touch or swipe his or her index finger when fingerprint data is required to identify the user in order to conduct a transaction (such as provide entry to a building). The biochemical sensor 230 may include one or more components and/or sensors operable to obtain user biological data, such as breath data and/or saliva from the user for biometric analysis. Other types of biological data could be obtained as well, which may be analyzed in some embodiments by the biometric authentication service system computer during a transaction.

In some embodiments, the data obtained by the motion sensor(s) 226, fingerprint sensor 228 and/or biochemical sensor 230 is transmitted from the user's mobile device 200 to the biometric authentication service system computer 104 (See FIG. 1), which may be a cloud-based computer system, for enrollment purposes and/or for processing to authenticate the user. In addition, in some embodiments, the mobile device processor 204 and receiver/transmitter circuitry 212 may be operable to transmit cardholder data and/or user financial transaction data and/or user mobile device data to the biometric authentication service system computer for use in authentication processing during a transaction.

It should also be understood that, in some implementations, more than one form of user identification data and/or user biometric data may be required to authenticate a user, for example, when certain types of transactions occur. For example, if a consumer is attempting to utilize a mobile device to purchase an expensive item from an online merchant (for example, a wristwatch valued at more than one thousand dollars) then several different types of user biometric data may be required by the biometric authentication service system computer in accordance with one or more merchant business rules in order to authenticate the user. For example, fingerprint data, photographic data representing the user's face to permit facial recognition processing, and global positioning service (GPS) data may be required in accordance with a merchant's business rules to securely authenticate the user before a purchase transaction is presented for purchase transaction authorization processing.

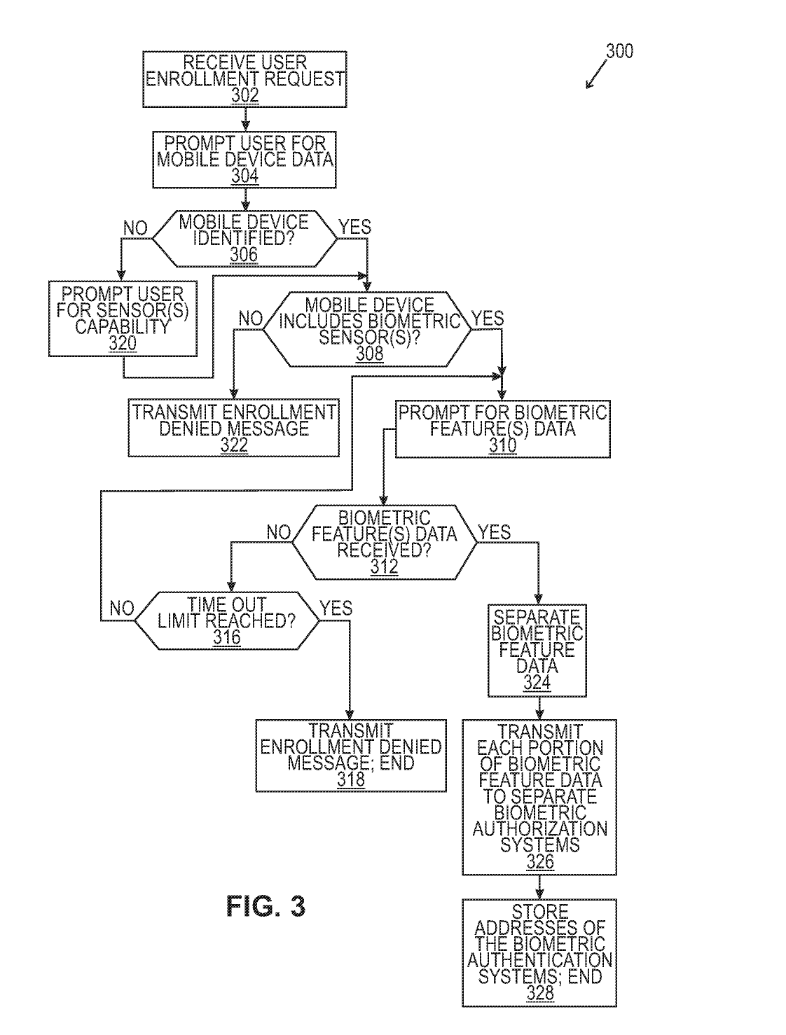

In some embodiments, users or consumers or cardholders may be required to enroll or register with the biometric authentication service system computer before being permitted to participate in the user biometric authentication service in accordance with methods described herein. Thus, FIG. 3 illustrates a user enrollment process 300 according to some embodiments. In particular, an authentication service computer receives 302 a user enrollment request from a user device, which may be a user mobile device as described above or some other type of electronic device, such as a desktop computer. The enrollment request may include user identification data, such as the user's name and residence address, a cardholder account number, and an e-mail address. In some embodiments, the biometric authentication service system computer may prompt 304 the user to provide user mobile device identification data, such as the mobile device type and/or the name of the model device and/or a serial number. The biometric authentication service system computer may then attempt to identify 306 the mobile device based on the provided mobile device identification data, for example, by checking a database containing mobile device type information. If the mobile device is identified, then the biometric authentication service system computer determines 308 if the mobile device includes one or more biometric components and/or biometric sensor(s). If so, then the biometric authentication service system computer prompts 310 the user to provide biometric feature(s) data in accordance with the one or more biometric components of the user's device.

In some embodiments, the user may be prompted to provide biometric feature data for each type of biometric sensor and/or biometric component supported by the user's mobile device. For example, if the user's mobile device includes a camera and a microphone, then the user may be prompted to take a picture of his or her face (i.e., for facial recognition purposes) and to say one or more sentences for capture by the microphone (i.e., for voice print and/or other type of audio authentication processing). In this manner biometric feature data associated with the user's face and with the user's voice is captured. For example, the biometric authentication service system computer may transmit a prompt for display on a display screen of the user's mobile device instructing the user to snap a picture of his or her face without a hat and without glasses, in addition to instructions for the user to recite a sentence or a combination of words in a normal voice into the microphone. The user's mobile device then transmits the photographic data of the user's face and the audio data of the user's voice to the biometric authentication service system computer for further processing as described herein. The same process may be repeated to obtain other types of user biometric feature data, and may only be limited by the type(s) of biometric components and/or sensors associated with the user's device. For example, if the user's device also includes a heart rate monitor, then he or she may be prompted to utilize that heartbeat monitor to provide heartbeat data while at rest.

Referring again to FIG. 3, when the required and/or appropriate biometric feature data is received 312, then the biometric authentication service system computer separates 324 the biometric feature data into two or more portions, thus generating a plurality of biometric feature portions data. For example, captured biometric feature data of a user's face for use in facial recognition may be divided up into user biometric data portions (i.e., facial data portions) such that a first data portion includes the eyes, a second data portion includes the nose, and a third data portion includes the mouth of the user. In another example, capture biometric feature data of a user's fingerprint may be fed or input to a separation algorithm configured for separating the fingerprint data into two or more pre-defined amounts (for example, pixel amounts or bytes), wherein each amount corresponds to a different portion of the overall fingerprint (for example, a left top quadrant portion, a right top quadrant portion, a lower left quadrant portion and a lower right quadrant portion). Each biometric feature portion is then transmitted 326 to separate biometric authentication system computers and stored by each, wherein the separate biometric authentication system computers are not informed of the existence of, and/or do not have the address(es) of, any of the other authentication system computers. Thus, continuing with the example above, the user biometric feature data portions corresponding to the user's eyes, nose and mouth are transmitted to separate first, second and third biometric authentication system computers where they are stored. Next, the biometric authentication service system computer stores 328 an indication, such as the internet protocol (IP) address, of each of the biometric authentication system computers that received a portion of the user biometric feature data in association with one or more user identifiers, and the process ends. In some implementations, the biometric authentication service system computer transmits a biometric authentication service enrollment success message to the user device so that the user is notified that his or her user device (for example, a mobile telephone) has been successfully enrolled in the biometric authentication service. In this manner, when the biometric authentication service system computer receives a request for user authentication during a transaction, the biometric authentication service system computer will be able to determine which biometric authentication system computers contain the portions of the user's biometric feature data, and then can conduct user authentication processing.

Referring again to FIG. 3, if in step 312 the biometric data is not received within a predetermined amount of time (typically in the range of about 15-30 seconds), and a time-out limit 316 has not been reached (typically in the range of about 30-90 seconds), then the user is again prompted 310 to provide the biometric data. However, if the required user biometric data again is not provided in step 312 and the time out limit is reached, then in some embodiments the authentication service computer transmits 318 an enrollment denied message to the user's mobile device, and the process ends. The enrollment denied message may serve as a prompt for the user to try again (by transmitting another enrollment request), and/or as an indication that one or more of the biometric sensors of the user's mobile device is not operating properly. Referring again to step 306 of FIG. 3, if the biometric authentication service system computer cannot identify the user's mobile device, then the user is prompted 320 to provide information concerning the biometric sensor(s) capabilities of his or her mobile device. If biometric sensors are available in step 308, then the biometric authentication service system computer prompts 310 the user for the appropriate biometric data and the process continues as explained above. However, if in step 308 it is determined that the user's mobile device does not contain any biometric sensors, then the biometric authentication service system computer transmits 322 an enrollment denied message stating that the user device is ineligible for use with the biometric authentication service because it does not contain any biometric sensors and the process ends. However, in some implementations, a user may be denied enrollment if his or her user device contains only one type of biometric sensor, such as a microphone, which may be due to business rules or other criteria associated with various types of transactions that require two or more forms of biometric data to be obtained during such transactions in order to authenticate a user.

Thus, a user may follow a process flow such as that illustrated by FIG. 3 to register or enroll by providing user biometric data that may include one or more different types of biometric data items. For example, a user may utilize his or her user mobile device to capture voice data (i.e., a voice print), and/or facial data, and/or other types of biometric data which then can be uploaded to the biometric authentication service system computer. Other types of user biometric data that can be utilized to authenticate the user includes, but is not limited to pulse data (i.e., heartbeat data), gait data (i.e., walking style data), iris scan data, and/or the like. The biometric authentication service system computer then separates each type of user biometric feature data into two or more biometric feature data portions and transmits the portions to separate biometric authentication system computers, which function in accordance with processes disclosed herein to perform user authentication processing on behalf of a plurality of different types of entities, and for a wide variety of different types of transactions and/or applications.

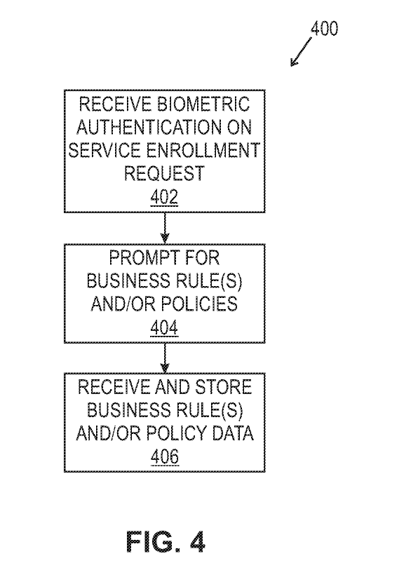

FIG. 4 is a flowchart illustrating an entity biometric authentication service enrollment process 400 in accordance with some embodiments. In particular, a biometric authentication service system computer receives 402 an enrollment request from an entity, for example, from an entity device such as a merchant server computer hosting a merchant website, or a merchant retail system computer, or a transit system server computer. The enrollment request may include entity identification data, such as the name of the entity, entity business address data, website identification data, and/or entity contact information. The biometric authentication service system computer may then prompt 404 the entity computer for one or more business rules and/or policies of the entity that are to be utilized when conducting transactions involving the entity and users. For example, if the entity is a merchant having a server computer hosting an online store, the merchant may specify or institute one or more business rules for authenticating consumers who shop online at the merchant's website and have loaded a shopping cart with merchandise to purchase. In such a case, an example of a business rule is one in which the merchant requires the user to be authenticated via one form of biometric feature data (such as via a facial recognition process) when the total purchase transaction price is greater than $50 but less than $250, but when the purchase transaction price exceeds $250 the user must also provide a second form of biometric feature data for authentication (for example, voice data so that a voice recognition process must be satisfied). It should be understood that many other types of business rules and/or policies can be provided and/or required by one or more entities for satisfaction with regard to authenticating a user during a particular type of transaction, which may which may depend on the entity involved in the transaction and/or the type of transaction.

Referring again to FIG. 4, after the biometric authentication service system computer next receives 406 and stores the business rule(s) data and/or policy data, for example, in an entity database. The business rules data and/or policy data may also be stored along with user identification data and/or entity identification data for use when the biometric authentication service system computer receives a request to authenticate a user during a transaction. When a user is authenticated, in some embodiments the biometric authentication service system computer transmits a user authentication message to the entity so that further transaction processing can occur. For example, if the entity is a merchant, then when the merchant receives a positive user authentication message (meaning that the user has been authenticated) with regard to a purchase transaction, then the merchant transmits the purchase transaction details to a payment network for authorization processing.

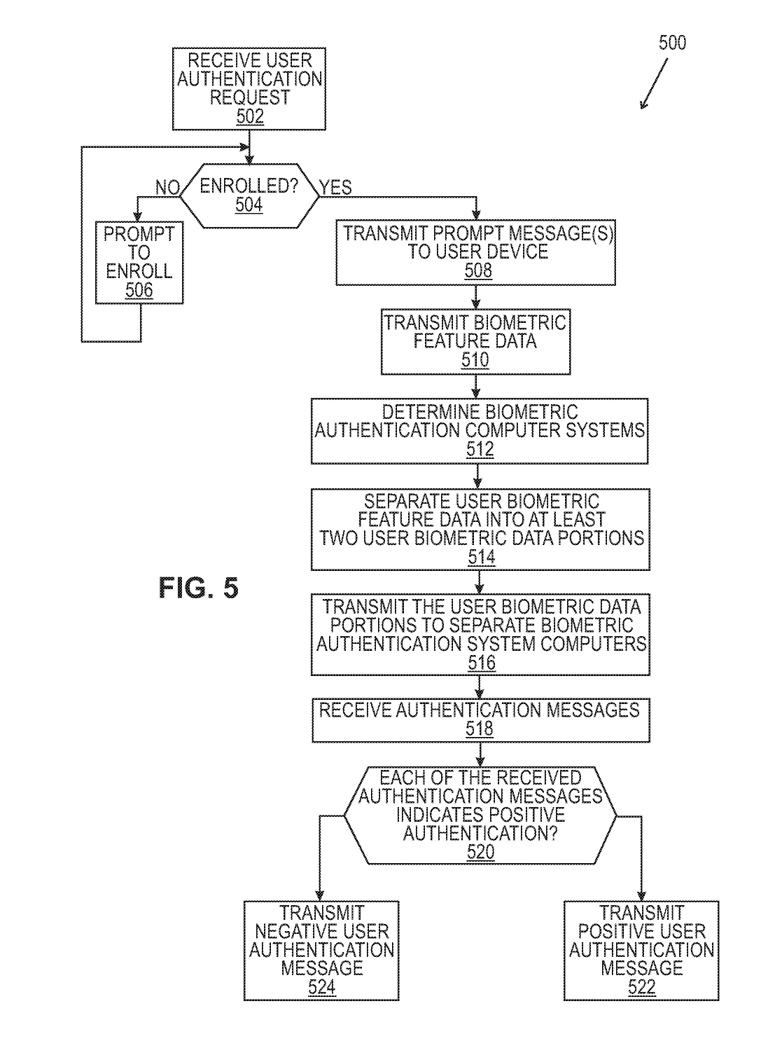

FIG. 5 is a flowchart illustrating a method for authenticating a user according to an embodiment. A biometric authentication service system computer receives 502 a user authentication request regarding a transaction from an entity computer. In some implementations, the user authentication request includes transaction data (such as a transaction amount, time of day, and/or merchandise or items involved in the transaction), user identification data, and/or entity identification data, and/or user device identification data. The biometric authentication service system computer then determines 504 (based on the user identification data) if the user is enrolled in a biometric authentication service, and if not prompts 506 the user to enroll. In some embodiments, the user enrolls in accordance with the process described above concerning FIG. 3, or does not enroll within a predetermined amount of time so the process ends (not shown). Once a determination is made that the user is enrolled 504, the biometric authentication service system computer transmits 508 a prompt message to a user device of the user, wherein the prompt message asks the user to provide at least one type of user biometric feature data (for example, the prompt message may be displayed on a display component of the user's mobile device for the user to state his or her name into a microphone for voice recognition processing). Next, the biometric authentication service system computer receives 510 the user biometric feature data from the user device and then determines 512 that at least two biometric authentication computer system computers are associated with the user identification data. The biometric authentication service system computer the separates 514 the user biometric feature data into at least two user biometric data portions, and transmits 516 each user biometric data portion to a separate biometric authentication system computer. The biometric authentication service system computer then receives 518 an authentication message from each of the at least two biometric authentication computer systems, and determines 520 whether each of the authentication messages from the at least two biometric authentication computer systems indicates positive authentication of the user. If so, then the biometric authentication service system computer transmits 522 a positive user authentication response to the entity computer. If in step 520 a determination is made that one or more of the authentication messages indicates a mismatch between the user biometric feature data portion captured during the transaction and stored data, then the biometric authentication service computer transmits a negative user authentication message to the entity involved in the transaction. Depending on the type of transaction, the biometric authentication service system computer may receive the user authentication request from a merchant device, a merchant acquirer financial institution (FI) computer, a merchant retail system computer, a mass transit server computer, an issuer financial institution (FI) computer, or other entity computer or server and the like. In addition, in some embodiments, the prompt message transmitted by the biometric authentication service system computer may be based on one or more business rules associated with and/or promulgated by the entity involved in the transaction. In such a case, the biometric authentication service system computer may generate a prompt message requesting user biometric feature data from the user as specified by the business rule(s) and then transmit it to the user device.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A biometric authentication method, comprising:
receiving, by a biometric authentication service system computer from an entity computer, a user authentication request, the user authentication request comprising transaction data, user identification data and entity identification data;
determining, by the biometric authentication service system computer based on the user identification data, that the user is enrolled in a biometric authentication service;
transmitting, by the biometric authentication service system computer to a user device of the user, a prompt message for the user to provide at least one type of user biometric feature data;
receiving, by the biometric authentication service system computer from the user device, the user biometric feature data;
determining, by the biometric authentication service computer, at least two biometric authentication computer system computers associated with the user identification data;
separating, by the biometric authentication service system computer, the user biometric feature data into at least two user biometric data portions;
transmitting, by the biometric authentication service system computer, each of the at least two user biometric data portions to a separate biometric authentication system computer;
receiving, by the biometric authentication service system computer from each of the at least two biometric authentication computer systems, an authentication message; and
transmitting, by the biometric authentication service system computer to the entity computer, a positive user authentication response when the authentication message from each of the at least two biometric authentication computer systems indicates positive authentication of the user.

2. The method of claim 1, further comprising transmitting, by the biometric authentication service computer to the entity computer, a transaction decline message when at least one authentication message from the at least two biometric authentication system computers indicates a mismatch between a stored biometric feature data portion and a user biometric feature data portion captured during the transaction.

3. The method of claim 1, wherein the biometric authentication service system computer receives the user authentication request from one of a merchant device, a merchant financial institution (FI) computer, or a merchant retail system computer.

4. The method of claim 1, wherein transmitting the prompt message for user biometric data further comprises:
determining, by the biometric authentication service system computer, that at least one business rule of an entity applies to the transaction;
generating, by the biometric authentication service system computer, a prompt message requesting user biometric feature data from the user as specified by the at least one business rule; and
transmitting, by the biometric authentication service system computer to the user device, the prompt message.

5. The method of claim 1, wherein the user authentication request further comprises user device identification data.

6. A biometric authentication system comprising:
a biometric authentication service computer;
a plurality of separate biometric authentication system computers operably connected to the biometric authentication service computer;
a payment network operably connected to the biometric authentication service computer;
a user mobile device configured for communications with the payment network and with the authentication service computer; and
a merchant computer operably connected to the biometric authentication service computer;
wherein the biometric authentication service computer includes at least one storage device storing instructions configured to cause the biometric authentication service computer to:
receive a user authentication request from the merchant computer, the user authentication request comprising transaction data, user identification data and entity identification data;
determine, based on the user identification data, that the user is enrolled in a biometric authentication service;
transmit a prompt message to the user mobile device for the user to provide at least one type of user biometric feature data;
receive the user biometric feature data from the user mobile device;
identify at least two biometric authentication computer system computers of the plurality of separate biometric authentication system computers that are associated with the user identification data;
separate the user biometric feature data into at least two user biometric data portions;
transmit each of the at least two user biometric data portions to the identified biometric authentication system computers;
receive an authentication message from each of the at least two biometric authentication system computers; and
transmit a positive user authentication response to the merchant computer when the authentication message from each of the at least two biometric authentication system computers indicates positive authentication of the user.

7. The system of claim 6, wherein the at least one storage device stores further instructions configured to cause the biometric authentication service computer to transmit a transaction decline message to the merchant computer when at least one authentication message from the at least two biometric authentication system computers indicates a mismatch between a stored biometric feature data portion and a user biometric feature data portion captured during the transaction.

8. The system of claim 6, wherein the instructions for transmitting the prompt message for user biometric data further comprises instructions configured to cause the biometric authentication service computer to:
determine that at least one business rule of an entity applies to the transaction;
generate a prompt message requesting user biometric feature data from the user as specified by the at least one business rule; and
transmit the prompt message to the user mobile device.

9. A biometric authentication service enrollment method, comprising:
receiving, by a biometric authentication service system computer from a user device, a user enrollment request;
transmitting, by the biometric authentication service system computer to the user device, a prompt for user mobile device data;
determining, by the biometric authentication service system computer, based on the user mobile device data that the mobile device is associated with at least one biometric sensor;
transmitting, by the biometric authentication service system computer to the user device, a prompt message for the user to provide at least one type of user biometric feature data;
receiving, by the biometric authentication service system computer from the user device, the user biometric feature data;
separating, by the biometric authentication service system computer, the user biometric feature data into at least two user biometric data portions; and
transmitting, by the biometric authentication service system computer, each of the at least two user biometric data portions to a separate biometric authentication system computer.

10. The method of claim 9, further comprising transmitting, by the biometric authentication service system computer, a biometric authentication service enrollment success message to the user device.

11. The method of claim 9, wherein the user enrollment request comprises user identification data and entity identification data, and further comprising:
identifying, by the biometric authentication service system computer based on at least one of the user identification data and entity identification data, at least one business rule of an entity associated with at least one type of transaction to associate with the user; and
storing, by the biometric authentication service system computer, the at least one business rule in association with the user identification data.

12. A biometric authentication service system comprising:
a biometric authentication service computer;
a plurality of separate biometric authentication system computers operably connected to the biometric authentication service computer; and
a user mobile device configured for communications with the payment network and with the authentication service computer;
wherein the biometric authentication service computer includes at least one storage device storing instructions configured to cause the biometric authentication service computer to:
receive a user enrollment request from the user mobile device;
transmit to the user mobile device, a prompt for user mobile device data;
determine, based on the user mobile device data, that the mobile device is associated with at least one biometric sensor;
transmit a prompt message to the user mobile device for the user to provide at least one type of user biometric feature data;
receive the user biometric feature data from the user device;
separate the user biometric feature data into at least two user biometric data portions; and
transmit each of the at least two user biometric data portions to a separate biometric authentication system computer.

13. The system of claim 12, wherein the at least one storage device stores further instructions configured to cause the biometric authentication service computer to transmit a biometric authentication service enrollment success message to the user device.

14. The system of claim 12, wherein the user enrollment request comprises user identification data and entity identification data and the at least one storage device stores further instructions configured to cause the biometric authentication service computer to:
identify, based on at least one of the user identification data and entity identification data, at least one business rule of an entity associated with at least one type of transaction to associate with the user; and
store the at least one business rule in association with the user identification data.
